(19) United States
(12) Patent Application Publication
(10) Pub. No.: US 2018/0300083 A1
(43) Pub. Date: Oct. 18, 2018

(54) WRITE-AHEAD LOGGING THROUGH A PLURALITY OF LOGGING BUFFERS USING NVM

(71) Applicant: Hewlett Packard Enterprise Development LP, Houston, TX (US)

(72) Inventors: Haris Volos, Palo Alto, CA (US); Hideaki Kimura, Palo Alto, CA (US); James Park, Palo Alto, CA (US); Daniel Fryer, Palo Alto, CA (US)

(21) Appl. No.: 15/485,399

(22) Filed: Apr. 12, 2017

(51) Int. Cl. G06F 3/06

(52) U.S. Cl. CPC G06F 3/0656; G06F 3/061; G06F 3/0685; G06F 3/0652; G06F 3/0638

(57) ABSTRACT

An example system for write-ahead logging through a plurality of logging buffers using a non-volatile memory (NVM) is disclosed. The example disclosed herein comprises a processing unit coupled to one or more controllers from one or more client applications. The example also comprises a plurality of logging buffers to receive a plurality of first log data threads based on a predetermined timestamp range, wherein each log buffer stores a single first timestamp log data thread from a plurality of timestamp log data threads. The example further comprises a flusher to flush the plurality of first timestamp log data threads from the plurality of logging buffers to a first timestamp log data. The flusher stores the first timestamp log data to an NVM to build flushed timestamp log data. The example further comprises a syncer to sync the flushed timestamp log data from the NVM to an HD device in time stamp sequential order.

### BACKGROUND

There are different approaches to recovery algorithms. For example, shadow copy mechanisms work by writing data to a new location, syncing it to disk and then atomically updating a pointer to point to the new location. Shadow copying may work well for large objects, but incurs a number of overheads due to fragmentation and disk seeks. Another example is Write-Ahead Logging (WAL), which provides update-in-place changes: a redo and/or undo log entry is written to the log before the update-in-place so that it can be redone or undone in case of a crash.

In computer science, WAL is a family of techniques for providing atomicity and durability in database systems. In a system using WAL, all modifications are written to a log before they are applied. The purpose of WAL may be illustrated in the following example. The example comprises a program that is in the middle of performing some operation when the machine it is running on lost power. Upon restart, the program may need to know whether the operation it was performing succeeded or not. If WAL is enabled, the program may check the WAL log and compare what it was supposed to be doing when it unexpectedly lost power to what was actually done. Based on the previous comparison, the program may decide to undo what it had started, complete what it had started, or keep things as they are.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 is a block diagram illustrating a system example for write-ahead logging through a plurality of logging buffers using NVM.

FIG. 2 is a block diagram illustrating a system example for write-ahead logging through a plurality of logging buffers using NVM, and metadata storage.

FIG. 3 is a flowchart of an example for write-ahead logging through a plurality of logging buffers using NVM.

FIG. 4 is a flowchart of an example for write-ahead logging through a plurality of logging buffers using NVM, via NV segments.

FIG. 5 is a block diagram illustrating another system example for write-ahead logging through a plurality of logging buffers using NVM.

### DETAILED DESCRIPTION

WAL is the central component in various examples that require significant durability such as database management systems (DBMS). WAL is different from many other data structures because WAL is highly optimized for append-to-end operations and sequential read-back (e.g. scan) operations. The better performance of WAL allows lower latency in database transactions' commits.

WAL logs may be stored in a memory device, such as non-volatile memory (NVM) or a Hard-Disk (HD). NVMs have low latency (e.g., high speeds that may be comprised around 60-300 ns) and small capacity (e.g. 8-32 GB). Disks (e.g. HDs and SSDs) have higher latency (e.g. low speeds that may be comprised around 15 us-10 ms) and larger capacity (e.g. 1 TB). As one example, WAL may store WAL logs in a NVM, for example, a Non-Volatile Dual In-line Memory Module (NVDIMM).

A NVDIMM is a computer memory Random-Access Memory (RAM) DIMM that retains data even when electrical power is removed either from an unexpected power loss, system crash or from a normal system shutdown. NVDIMMs may be used to improve application performance, data security, and system crash recovery time. The durability and low-latency of NVDIMM may be preferred for WAL. However, existing client applications (e.g. databases that write WAL through log data threads) may need changes in their WAL module to fully exploit NVDIMM. In examples where the WAL log is stored solely in NVRAM, the size of the log is limited by the amount of available NVRAM.

An enhanced system and method to perform WAL is disclosed. The enhanced system and method combine the low latency of NVM and the high capacity of HD. Client applications may perform WAL logging in parallel through the plurality of logging buffers. Examples of the present disclosure comprise a processing unit coupled to one or more controllers from one or more client applications. The examples further comprise a plurality of logging buffers to receive a plurality of first log data threads based on a predetermined timestamp range, wherein each log buffer stores a single first timestamp log data thread from a plurality of timestamp log data threads. The example further comprises a flusher to flush the plurality of first timestamp log data threads from the plurality of logging buffers, to a first timestamp log data; the flusher is configured to store the first timestamp log data to an NVM to build flushed timestamp log data. The examples further comprise the NVM and a syncer to sync the flushed timestamp log data from the NVM to a HD device in timestamp sequential order.

The following discussion is directed to various examples of the disclosure. The examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

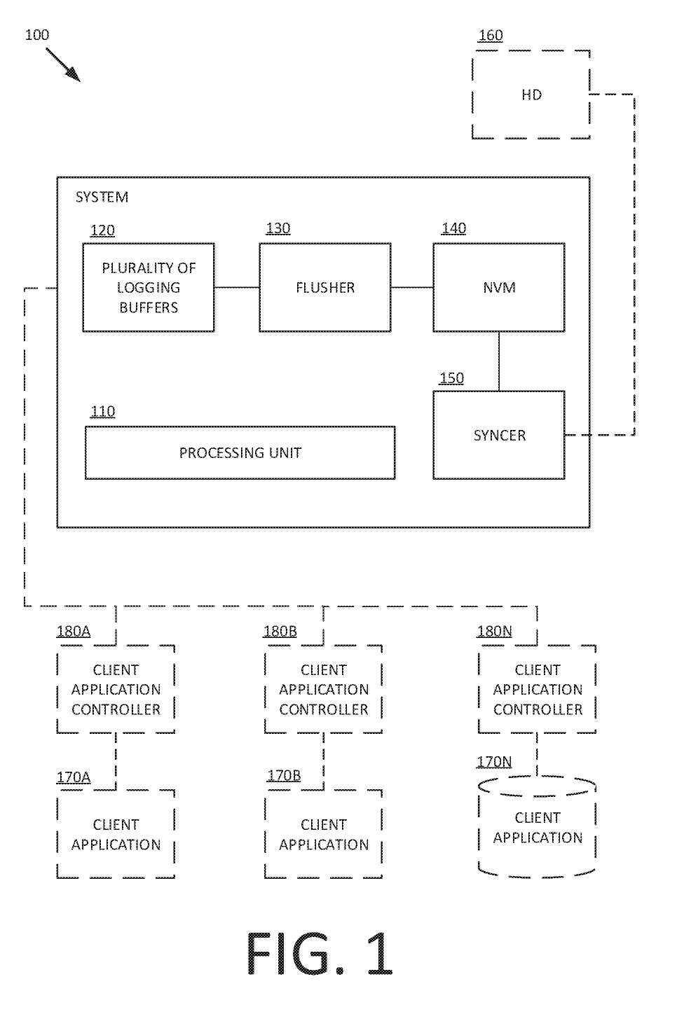

Now referring to the drawings, FIG. 1 is a block diagram illustrating a system example for write-ahead logging through a plurality of logging buffers using NVM. The system 100 comprises a processing unit 110, a plurality of logging buffers 120, a flusher 130, a NVM 140, and syncer 150. The system 100 is connected to an HD 160 and one or more of client application controllers 180A-180N. The client application controllers 180A-180N are further connected to one or more of client applications 170A-170N.

The client applications 170A-170N may be a database management system (DBMS) that write WAL through log data threads, and each client application may input one or more log data threads. For example, a system may be connected to three client applications: a first client application (e.g. CA1), a second client application (e.g. CA2) and a third client application (e.g. CA3). CA1 may provide one log data thread to the system (e.g. LDT11), CA2 may provide four log data threads to the system (e.g. LDT21, LDT22, LDT23, and LDT24), and CA3 may not provide any data thread to the system. In this example, the system connected to three client applications CA1-CA3 may have an input of five log data threads: one log data thread from CA1 (LDT11), and four log data threads from CA2 (LDT21, LDT22, LDT23, LDT24). Each log data thread may produce one or more log entries.

System 100 is based on timestamps (e.g. Epochs). As generally described herein, a timestamp represents a pre-defined duration of time. In the present disclosure, the term epoch may be understood as an application-defined period marked by distinctive features or events. An epoch or timestamp may be determined by the user or by a client application 170A-170N. Depending on the type of client applications 170A-170N, it may correspond to one transaction (e.g. 10 seconds). The application timestamp is coarse-grained, not like a nanosecond or Read Time-Stamp Counter (RDTSC). Each timestamp may contain from one to millions or more of log entries. Each log entry may belong to one timestamp, which represents when the log is written and becomes durable (e.g. when the log is stored in the NVM). For example, if a predetermined timestamp duration is 10 seconds, and the spot time (benchmark time) is referenced as T; the first timestamp comprises from T seconds to T+10 s; the second timestamp comprises from T+10 s to T+20 s; and so on, up to the Nth timestamp that comprises from T+(N−1)*10 s to T+N*10 s wherein N is a positive integer.

System 100 comprises a plurality of logging buffers 120. The plurality of logging buffers 120 are adapted to receive the plurality of log data threads per timestamp. The processing unit 110 writes each log data thread into a single logging buffer, from the plurality of logging buffers 120. For example, if the system is inputted with five log data threads (e.g. LDT1, LDT2, LDT3, LDT4, LDT5), the processing unit may write the log data threads logs from each log data thread in a separate logging buffer in parallel. Therefore, following with the example, the system would need five logging buffers (e.g. LB1, LB2, LB3, LB4, LB5.). For example, logs from LDT1 may be written in LB1, logs from LDT2 may be written in LB2, logs from LDT3 may be written in LB3, logs from LDT4 may be written in LB4, and logs from LDT5 may be written in LB5. If a log data thread comprises logs from more than one timestamp, the logs from each timestamp may be written in a separate logging buffer. For example, a log data thread comprises logs from more than one timestamp (e.g. logs A from timestamp A and logs B from timestamp B, with timestamp B following timestamp A). Logs A from timestamp A may be written in a first logging buffer (e.g. LB_A) and logs B from timestamp B may be written in a second logging buffer (e.g. LB_B). One or more of the buffers from the plurality of logging buffers 120 may be circular buffers. As the plurality of logging buffers 120 are written in parallel, there can be an arbitrary number of logging buffers to fully utilize the bandwidth of the system 100, therefore optimizing the computing resources of the system 100.

The term circular buffer, also known in the art as circular queue, cyclic buffer or ring buffer, may be understood as a data structure that uses a single, fixed-size buffer as if it was connected end-to-end. A circular buffer is a First-In First-Out (FIFO) buffer, therefore the first data unit written in the buffer (the oldest in the buffer) is the first data unit to be replaced. Non-circular standard buffers can use the Last-In First-Out (LIFO) protocol.

Once timestamp logs from the plurality of log data threads from that timestamp are written in the plurality of logging buffers 120, an Application Programming Interface (API) may inform the flusher 130 of the newly written logs. An API is a set of subroutine definitions, protocols, and tools for building an application. In general terms, API may be understood as a set of clearly defined methods of communication between various components.

System 100 comprises a single flusher 130 which is responsible for monitoring log activities from the plurality of logging buffers 120. The flusher 130 accesses the plurality of logging buffers 120 written logs per timestamp, hereinafter referred to as the plurality of timestamp log data, and writes them in the NVM 140. The flusher 130, may further release the plurality of logging buffers 120 so that they can be used again. For example, a system has three logging buffers (e.g. LB1, LB2, LB3) with the logs from a first timestamp; the logs from the first timestamp written in LB1 (e.g. LFT1), the logs from the first timestamp written in LB2 (e.g. LFT2); and the logs from the first timestamp written in LB3 (e.g. LFT3); then the plurality of timestamp log data comprises LFT1, LFT2, and LFT3. In the example, the flusher accesses to LFT1, LFT2 and LFT 3 from LB1, LB2, and LB3; and writes LFT1, LFT2, and LFT3 to the NVM; then the flusher releases LB1, LB2, and LB3 so that the processing unit can use them to write logs from a following timestamp. In order to achieve maximum flexibility, the system 100 may release the client applications 170A-170N to launch a flusher thread and invoke the flusher function themselves, rather than launching it by the processing unit 110.

In some examples, a fixed segment size is predetermined by the user or a client application 170A-170N. If the timestamp log data to be flushed by the flusher 130 is bigger in size than the predetermined segment size, then the flusher 130 may divide the timestamp log data into a plurality of non-volatile (NV) segments, wherein the NV segment is smaller in size than the timestamp log data. Then the flusher 130 may store the NV segments in the NVM 140 in NV segment creation sequential order. For example, a user may specify a segment size of 100 Megabytes (Mb). The flusher may then need to flush a timestamp log data of 400 (Mb), then divide the 100 Mb timestamp log data into four NV segments: the first NV segment (e.g. NVS1) comprises the timestamp log data from 1 Mb-100 Mb, the second NV segment (e.g. NVS2) comprises the timestamp log data from 101 Mb-200 Mb, the third NV segment (e.g. NVS3) comprises the timestamp log data from 201 Mb-300 Mb, and the fourth NV segment (e.g. NVS4) comprises the timestamp log data from 301 Mb-400 Mb. Then the flusher 130 may first store the NVS1 into the NVM 140, store the NVS2 into the NVM 140, store the NVS3 into the NVM 140, and finally the flusher 130 may store the NVS4 into the NVM 140.

The NVM 140 stores the timestamp log data flushed by the flusher 130. Once the logs from the flushed timestamp log data are stored in the NVM 140, they are persistent and therefore, the flushed timestamp log data are not lost if the NVM 140 runs out of power or the system 100 crashes. Since the flushed log data is flushed in timestamp sequential order by the flusher 130, the log data is also stored in the NVM 140 in timestamp sequential order. An example of NVM 140 may be a NVDIMM. NVM 140 may be a small and fast memory.

System 100 further comprises a single syncer 150 to sync the flushed timestamp log data from the NVM 140 to the HD device 160 in timestamp sequential order. In order to achieve maximum flexibility, the system 100 may release the client applications 170A-170N to launch a syncer 150 thread and invoke the syncer function themselves, rather than launching it through the processing unit 110. For further flexibility and use of time maximization, syncer 150 may sync timestamp log data from the NVM 140 to the HD device 160 at the same time as the flusher 130 flushes the timestamp log data from the plurality of logging buffers 120 to the NVM 140. In the case that the NVM 140 stores a plurality of NV segments, the syncer 150 may sync the plurality of NV segments from the NVM 140 to the HD device 160 in timestamp sequential order. For example, NVM 140 may store four segments (e.g. NVS1, NVS2, NVS3, NVS4), wherein NVS1 may be the first segment that was stored in the NVM 140, NVS2 may be the second segment that was stored in the NVM 140, NVS3 may be the third segment that was stored in the NVM 140, and NVS4 may be the fourth segment that was stored in the NVM 140; then the syncer 150 may first sync NVS1 to the HD 160, then the syncer may sync NVS2 to the HD 160, then the syncer 150 may sync NVS3 to the HD 160, and then the syncer 150 may sync NVS4 to the HD 160. As another example, at the same time the syncer 150 is syncing an NV segment from the NVM 140 to the HD 160, the flusher 130 may flush an NV segment to the NVM 140.

Client applications 170A-170N may have varying mappings between their own notions of timestamps, therefore the present disclosure differentiates timestamp-based client applications, and non-timestamp-based client applications. Timestamp-based client applications (e.g. FOEDUS, SILO, etc.) are mapped to timestamps without any hassle, since the architecture is based on timestamps. However, non-timestamp-based applications are not mapped directly. Non-timestamp-based applications (e.g. MySQL, PostgreSQL, etc.) may be mapped by considering every transaction as a timestamp. In the present disclosure, the term transaction may be understood as a grouping of multiple operations, wherein the user of the client application may decide the grouping criteria.

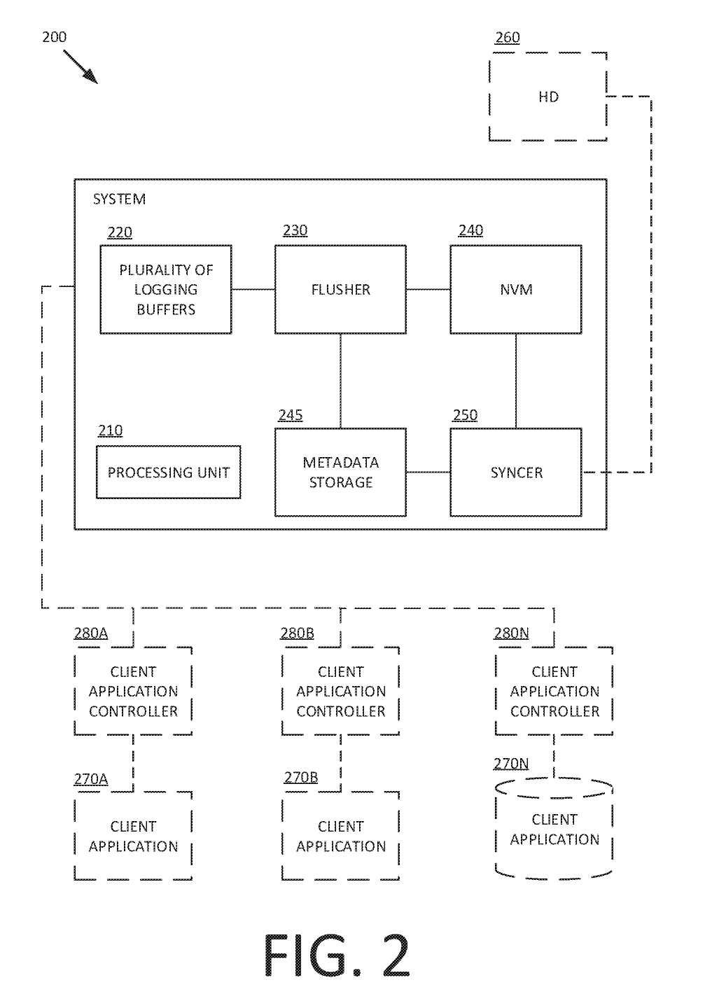

FIG. 2 is a block diagram illustrating a system example for write-ahead logging through a plurality of logging buffers using NVM, and metadata storage. The system 200 comprises a processing unit 210, a plurality of logging buffers 220, a flusher 230, an NVM 240, a metadata storage 245, and a syncer 250. The system 200 is connected to an HD 260 and one or more of client application controllers 280A-280N. The client application controllers 280A-280N are further connected to one or more of client applications 270A-270N. The client applications 270A-270N may be a DBMS that write WAL through log data threads. Each client application 270A-270N may input one or more log data threads.

System 200 is based on timestamps (e.g. Epochs) representing a pre-defined duration of time, which may be determined by the user or by a client application 270A-270N. Depending on the type of client applications 270A-270N, the timestamp may correspond to one transaction (e.g. 10 seconds). The application timestamp is coarse-grained, not like a nanosecond or RDTSC. Each timestamp may contain from one to millions or more of log entries. Each log entry may belong to one timestamp, representing when the log is written and becomes durable (e.g. when the log is stored in the NVM).

System 200 comprises a plurality of logging buffers 220. The plurality of logging buffers 220 are adapted to receive the plurality of log data threads per timestamp. The processing unit 210 writes each log data thread into a single logging buffer, from the plurality of logging buffers 220. Therefore, the processing unit 210 may write the log data threads logs from each log data thread in a separate logging buffer in parallel. If a log data thread comprises logs from more than one timestamp, the logs from each timestamp may be written in a separate logging buffer. One or more of the buffers from the plurality of logging buffers 220 may be circular buffers. As the plurality of logging buffers 220 are written in parallel, there can be an arbitrary number of logging buffers to fully utilize the bandwidth of the system 200, therefore optimizing the computing resources of the system 200.

Once a timestamp logs from the plurality of log data threads from that timestamp are written in the plurality of logging buffers 220, an API (not shown) may inform the flusher 230 of the newly written logs. An API is a set of subroutine definitions, protocols, and tools for building an application. In general terms, an API may be understood as a set of clearly defined methods of communication between various components.

System 200 comprises a single flusher 230 which is responsible for monitoring log activities from the plurality of logging buffers 220. The flusher 230 accesses the plurality of logging buffers 220 written logs per timestamp, hereinafter referred to as the plurality of timestamp log data, and writes them in the NVM 240. The flusher 230, may further release the plurality of logging buffers 220 so that they can be used again. In order to achieve maximum flexibility, the system 200 may release the client applications 270A-270N to launch a flusher thread and invoke the flusher function themselves, rather than launching it by the processing unit 210.

In some examples, a fixed segment size is predetermined by the user or a client application 270A-270N. If the timestamp log data to be flushed by the flusher 230 is bigger in size than the predetermined segment size, then the flusher 230 may divide the timestamp log data into a plurality of NV segments, wherein the NV segment is smaller in size than the timestamp log data. Then the flusher 230 may store the NV segments in the NVM 240 in NV segment creation sequential order.

System 200 comprises a metadata storage 245 to store timestamp metadata. The metadata storage 245 may provide a persistent store for storing timestamp metadata information per timestamp. The metadata storage 245 may be able to separate timestamp data (e.g. plurality of first epoch log data threads) stored in the NVM 240 from timestamp metadata stored in the metadata storage 245. Doing so enables the system 200 to directly map the timestamp data onto a contiguous memory access range in the NVM 240.

In one example, the metadata storage 245 may be an independent persistent storage. The metadata storage 245 stores timestamp metadata in a memory (e.g. M1), and the NVM 240 stores timestamp log data in a separate memory than M1 (e.g. M2). In another example, the metadata storage 245 may be a specific part reserved to store metadata within the NVM 240; therefore the NVM 240 may split into two parts (e.g. NVM_data and NVM_metadata), wherein the NVM_data stores timestamp log data and the NVM_metadata stores timestamp metadata. In the previous example, the NVM_metadata may be smaller in size than the NVM_data, since metadata (e.g. timestamp metadata) is smaller in size than data (e.g. log timestamp data). In both of the previous examples, data and metadata are stored separately and not mixed, which leads to the technical advantage that the metadata is not visible to the client applications 270A-270N and the data (what is written in the log) is visible to the client applications 270A-270N. The previous is a technical advantage due to the fact that the metadata used to track timestamp data is internal to the system, and it is not desired to expose it to the client application. Another technical advantage of storing separate data and its associate metadata is that otherwise, once the client application 270A-270N wants to read the log, it may be hard to separate what is data from what is metadata.

The timestamp metadata to be stored into the metadata storage 245 may comprise, for example, a timestamp length parameter, a NV segments size, a HD storing policy, a timestamp barrier bookmark, and a marker metadata. The previous may be understood as examples, and therefore the timestamp metadata may not be limited by them. The timestamp length parameter may define the length of each of the timestamp (e.g. timestamp predetermined duration of 10 [s]); the timestamp length parameter may be defined by the user or a client application 270A-270N. The NV segments size may define the length of each NV segment. The HD storing policy may define the policy to follow to sync the timestamp log data or the NV segments from the NVM 240 to the HI) 260. As a first example, the HD storing policy may be to sync from the NVM 240 to the HD 260 once the NVM 240 is full. As a second example, the HD storing policy may be to sync from the NVM 240 to the HD 260 once the NVM 240 is in a percentage of its full capacity (e.g. when NVM 240 hits its 60% of total capacity). Further, as a third example, the HD storing policy may be to sync from the NVM 240 to the HD 260 in continuous manner so that that the NVM 240 remains continuously in a percentage of its full capacity and the sync is performed following a FIFO protocol (e.g. the NVM 240 in its 80% of total capacity). As a fourth example, the HD storing policy may be to sync from the NVM 240 to the HD 260 once the NVM 240 contains timestamp log data from a predetermined number of timestamps (e.g. the NVM 240 contains timestamp log data or NV segments from four different timestamps). In the fourth example, the predetermined number of timestamps may also be stored in the metadata storage 245. The timestamp barrier bookmark may point to the borderline between two consecutive timestamps (e.g. TBM34 may point to the borderline between the third timestamp log data and the fourth timestamp log data). The marker metadata may point to the borderline between two consecutive timestamps within a NV segment, whereby the NV segment contains timestamp log data from more than one timestamp (e.g. NV segment NV_34 contains timestamp log data from the third timestamp and the fourth timestamp, then the NV_34 may further contain a marker metadata MM_34 that points to the borderline between the third timestamp log data and the fourth timestamp log data within the NV_34). The metadata storage 245 may also include metadata the client application 270A-270N wants to associate with the timestamp (e.g. timestamp tags).

The metadata storage 245 supports a Writing function, to write timestamp metadata for monotonically increasing timestamps, a Truncating function, to truncate storage to include timestamp metadata up to a given timestamp identifier and discard the rest, and a Reading function, to read timestamp metadata for a give range of timestamps.

The writing function supported by the metadata storage 245 takes advantage of the fact that timestamps are monotonically increasing. The writing function leverages this to write timestamp metadata to the HD 260 sequentially using, for example, a log structure layout and, therefore, maximizing effective HD 260 bandwidth. The system 200 writes timestamp log data in an intermediate durable NVM 240 to achieve low latency, since the NVM 240 is faster than the HD 260. During normal operation, the system 200 may write a metadata entry to the metadata storage 240 and ensure that the metadata entry is durably stored. The system 200 may further indicate as another metadata entry the latest timestamp (e.g. third timestamp) that was written to the store (e.g. NVM 240 and metadata storage 245). Occasionally, based on the HD storing policy, the metadata storage 245 transfers its contents out to HD 260. One example for transferring metadata from the metadata storage 245 to the HD 260 is made by first writing the associated data from the NVM 240 and the metadata from the metadata storage 245 to the HD 260 and then updating the timestamp marker to a durable timestamp marker (both stored in the metadata storage 245) to indicate the latest timestamp that was transferred and written to the HD 260. The metadata storage 245 contents that were transferred to HD 260 may then be recycled by writing new metadata entries, following a FIFO protocol. In the present disclosure, the durable timestamp marker may also be called a timestamp barrier bookmark.

The previous update protocol may ensure that crashes that happen during writes do not corrupt the metadata storage 245. There may be two crash scenarios to consider. As a first example, crashes may happen during writes to the metadata storage 245; since the durable timestamp marker is updated only after the metadata entry is written, the durable timestamp marker may point to successfully persisted timestamp metadata entries. As a second example, crashes may happen when transferring metadata entries from the metadata storage 245 to the HD 260, which can result in a partially written metadata entry. Since the metadata storage 245 updates the durable timestamp marker only after the transfer is completed, system 200 may use the durable timestamp marker to find the location of the latest transferred timestamp metadata entries in the HD 260 and truncate the metadata entry to remove the partially written metadata entries after the durable timestamp marker. The previous examples may also apply to the corresponding timestamp log data thread entries from the NVM 240 to the HD 260.

The truncating function supported by the metadata storage 245 sets the latest durable timestamp marker to point to the new latest timestamp, and takes extra steps to ensure that the new latest durable timestamp, or truncation point, always points to the metadata storage 245 for timestamp metadata entries, and to NVM 240 for timestamp log data. As one example, the truncation point falls into the metadata storage 245 or the NVM 260, then the truncation is complete and no further action may be required. As another example, the truncation point falls into the HD 260, then the truncation needs to ensure that the metadata storage 245 (or NVM 240) contains the latest durable timestamp. To ensure the previous, the system 200 first copies the HD 260 page containing the new durable timestamp to the metadata storage 245 (or NVM 240), sets the durable timestamp marker as the previous timestamp from the durable timestamp marker contained in the metadata storage 245 (or NVM 240, and then truncates the HD 260 files to the new durable timestamp marker. The previous order of operations ensures that the metadata storage 245 (or NVM 240) can complete a truncation interrupted by a crash.

The reading function supported by the metadata storage 245 reads through an iterator interface that allows iterating over a range of timestamps. The iterator interface hides the intermediate NVM 240 and metadata storage 245 from the user. The iterator may transparently read directly from the metadata storage 245 when the timestamp metadata falls into the metadata storage 245, or otherwise reads from the HD 260. When reading timestamp metadata from the HD 260, the iterator interface prefetches multiple entries into a private buffer to amortize HD 260 access over multiple metadata reads and maximize HD read bandwidth.

As an example, to enable scalable concurrency, reads may be optimistic with no locking involved, therefore exposing a reader to race conditions when recycling the metadata storage 245. It may be possible that while a concurrent reader finds and tries to read a timestamp log from a page from the metadata storage 245, the system 200 evicts and recycles that timestamp log. In order to detect the previous scenario, the metadata storage 245 may keep the page number of the currently evicted and recycled page. The page number is monotonically increasing so it may be used as a version number. After a page is evicted but before it is recycled, system 200 may update the metadata storage 245 page number to the new page number. Since page numbers increase monotonically, a reader can detect a page recycle by first reading the page number of the metadata storage 245, then reading the timestamp log, and finally re-reading the page number of the metadata storage 245 to validate that the metadata storage 245 page has not been recycled, which may imply that no version change has occurred.

In order to read a range of durable timestamp logs, system 200 may export a log cursor interface. The log cursor interface may comprise operations for creating, initializing, advancing, reading, and destroying cursors. However, the present disclosure focuses on the cursor point interface for advancing a cursor to the next available timestamp and reading the timestamp log data.

When a log cursor is created and initialized, it may initially point to the first durable timestamp in the given range of timestamps. The advancing stage may move to the next timestamp accessible through the log cursor. As one example, the log cursor points to a timestamp that is found in the HD 260, then the log cursor transparently maps the flushed timestamp log data or NV segments to the process virtual address space, and then returns the virtual address that maps to the beginning of the timestamp. As another example, the log cursor points to a timestamp that is found in the NVM 240, then the timestamp log data or NV segments stored in the NVM 240 are already mapped into the process virtual address space, and the log cursor returns the virtual address that maps to the beginning of the timestamp. After returning the virtual address that maps the timestamp, the user can directly access the timestamp log data through the memory interface. Due to the fact that timestamps may be broken into multiple NV segments, advancing a log cursor may not always point to next timestamp. In that case, the timestamp may be broken into multiple mappings, and the advancing phase may update the log cursor to point to the next mapping accessible.

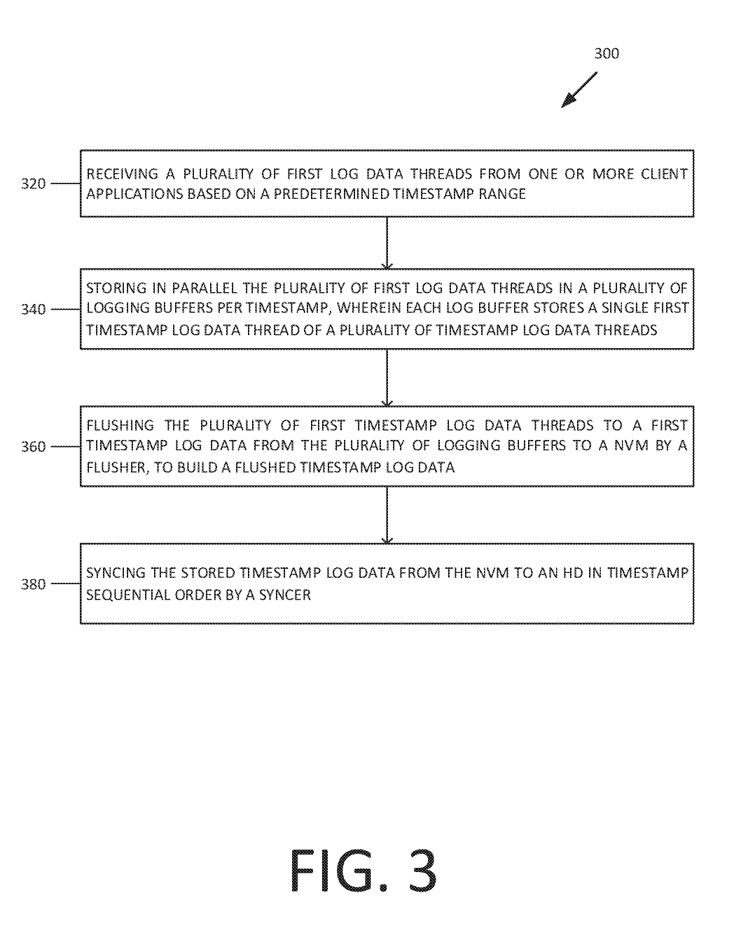

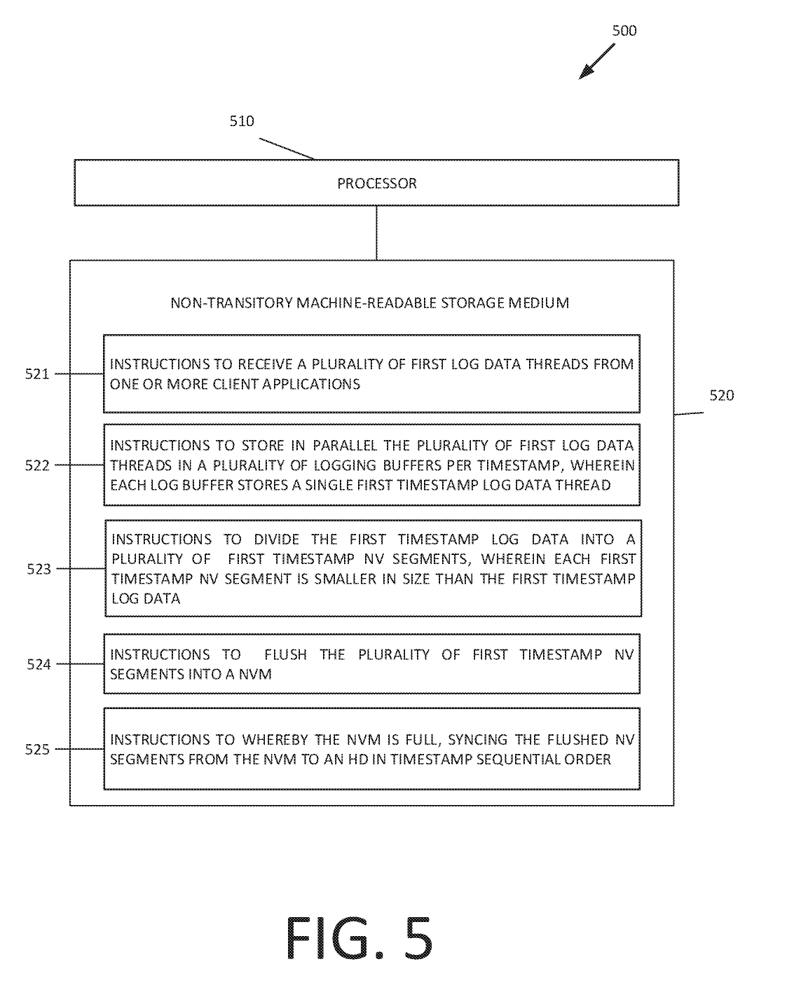

FIG. 3 is a flowchart of an example for write-ahead logging through a plurality of logging buffers using an NVM. Method 300 as well as the methods described herein can, for example, be implemented in the form of machine readable instructions stored in a memory of a computing system (see, e.g. the implementation of system 500 of FIG. 5), in the form of electronic circuitry or another suitable form. Method 300 may be used by system 100 from FIG. 1. Method 300 may also be used by system 200 from FIG. 2.

At block 320, the method 300 receives a plurality of first log data threads from one or more client applications based on a predetermined timestamp range. The predetermined timestamp range may be an Epoch determined by the one or more client applications.

At block 340, the method 300 stores in parallel the plurality of first log data threads in a plurality of logging buffers per timestamp, wherein each log buffer stores a single first timestamp log data thread of a plurality of timestamp log data threads.

At block 360, the method 300 flushes the plurality of first timestamp log data threads to a first timestamp log data from the plurality of logging buffers to an NVM by a flusher, to build a flushed timestamp log data. The flusher may be launched by a client application controller from the client application.

At block 380, the method 300 syncs the stored timestamp log data from the NVM to an HD in timestamp sequential order by a syncer. The syncer may be launched by a client application controller from the client application. The timestamp log data (e.g. the first timestamp log data) from the NVM may be synced in the HD asynchronously based on an HD storing policy previously defined by a user or client application.

In an example, the method 300 may further comprise a client application that is not a timestamp based client application and map each timestamp as a transaction and each transaction as a timestamp.

In another example, the method 300 may further comprise a metadata storing step. The method 300 may further comprise a storing a predetermined length parameter into the metadata storage, and opening and closing timestamps based on the predetermined timestamp length parameter. The method 300 may further comprise storing a timestamp barrier bookmark into the metadata storage.

In a further example, the method 300 is recovering after a system (e.g. system 100 from FIG. 1) fail within a second timestamp, wherein the first timestamp log data and a second timestamp log data are stored in the NVM. The method may further comprise dropping a second timestamp log data based on the timestamp barrier bookmark previously stored in the metadata storage.

In another example, the method 300 may further include a client application from the one or more client applications that read the stored timestamp log data via a log cursor.

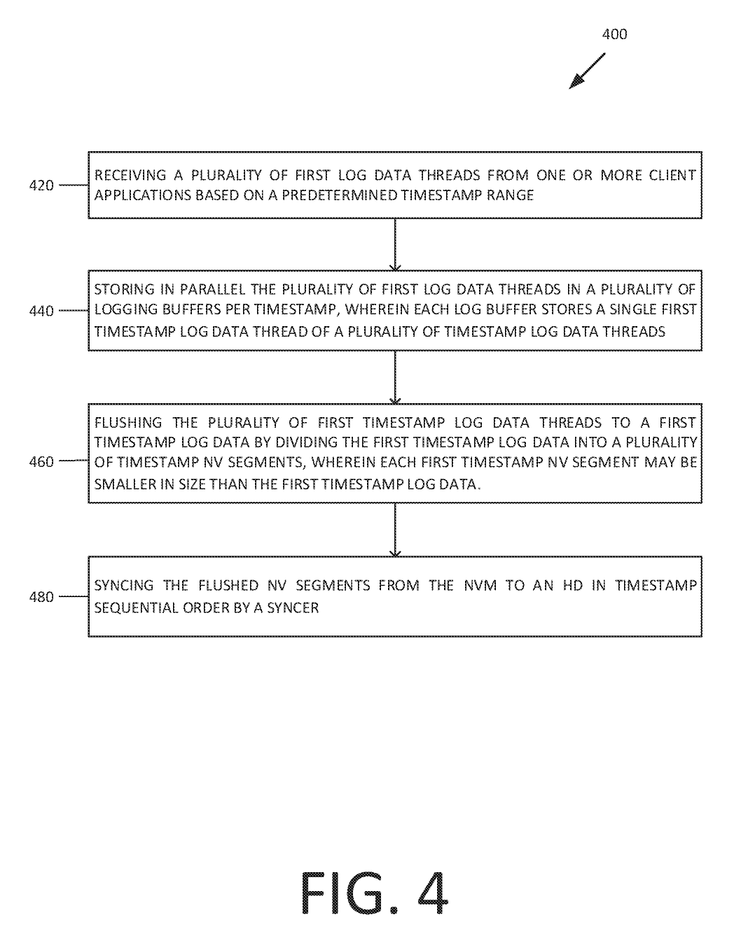

FIG. 4 is a flowchart of an example for write-ahead logging through a plurality of logging buffers using NVM, via NV segments. Method 400 as well as the methods described herein can, for example, be implemented in the form of machine readable instructions stored in a memory of a computing system (see, e.g. the implementation of system 500 of FIG. 5), in the form of electronic circuitry or another suitable form. Method 400 may be used by system 100 from FIG. 1, system 200 from FIG. 2, or another such system.

At block 420, the method 400 receives a plurality of first log data threads from one or more client applications based on a predetermined timestamp range. The predetermined timestamp range may be an Epoch determined by the one or more of client applications.

At block 440, the method 400 comprises storing in parallel the plurality of first log data threads in a plurality of logging buffers per timestamp, wherein each log buffer stores a single first time stamp log data thread of a plurality of timestamp log data threads.

At block 460, the method 400 comprises flushing the plurality of first timestamp log data threads to a first timestamp log data by dividing the first timestamp log data into a plurality of timestamp NV segments, wherein each first timestamp NV segment may be smaller in size than the first timestamp log data. The flusher may be launched by a client application controller from the client application.

At block 480, the method 400 comprises syncing the flushed NV segments from the NVM to an HD in timestamp sequential order by a syncer. The syncer may be launched by a client application controller from the client application. The NV segments from the NVM may be synced in the HD asynchronously based on an HD storing policy previously defined by a user or client application. The NV segments size may be decided wither by a user or a client application controller.

In an example, in the case of a timestamp based client application, the method may further comprise mapping each timestamp as a transaction and each transaction as a timestamp.

In another example, the method 400 may further comprise a metadata storing step. The method 400 may further comprise storing a predetermined length parameter into the metadata storage, and opening and closing timestamps based on the predetermined timestamp length parameter. The method 400 may further comprise storing a timestamp barrier bookmark into the metadata storage. The method 400 may further comprise sharing a timestamp NV segment by multiple timestamps divided by a marker, and storing the marker metadata into a metadata storage.

In a further example, the method 400 is recovering after a system (e.g. system 100 from FIG. 1) fail within a second timestamp, wherein the first timestamp NV segments and second timestamp NV segments are stored in the NVM. The method may further comprise dropping a second time stamp NV segment based on the timestamp barrier bookmark previously stored in the metadata storage.

In another example, the method 400 may further include a client application from the one or more client applications reading the stored timestamp NV segments via a log cursor.

FIG. 5 is a block diagram illustrating a system example for write-ahead logging through a plurality of logging buffers using an NVM. FIG. 5 describes a system 500 that includes a physical processor 510 and a non-transitory machine-readable storage medium 520. The processor 510 may be a microcontroller, a microprocessor, a central processing unit (CPU) core, an application-specific-integrated circuit (ASIC), a field programmable gate array (FPGA), and/or the like. The machine-readable storage medium 520 may store or be encoded with instructions 521-525 that may be executed by the processor 510 to perform the functionality described herein. System 500 may be connected to an HD. The system 500 may be further connected to one or more of client application controllers, and the client application controllers may be further connected to one or more client applications. System 500 entities may be the same or similar as the entities in system 100 of FIG. 1. System 500 may use the method 300 of FIG. 3.

In an example, the instructions 521-525, and/or other instructions can be part of an installation package that can be executed by processor 510 to implement the functionality described herein. In such a case, non-transitory machine readable storage medium 520 may be a portable medium such as a CD, DVD, or flash device or a memory maintained by a computing device from which the installation package can be downloaded and installed. In another example, the program instructions may be part of an application or applications already installed in the non-transitory machine-readable storage medium 520.

The non-transitory machine readable storage medium 520 may be any electronic, magnetic, optical, or other physical storage device that contains or stores executable data accessible to the system 500. Thus, non-transitory machine readable storage medium 520 may be, for example, a Random Access Memory (RAM), an Electrically Erasable Programmable Read-Only Memory (EEPROM), a storage device, an optical disc, and the like. The non-transitory machine readable storage medium 520 does not encompass transitory propagating signals. Non-transitory machine readable storage medium 520 may be allocated in the system 500 and/or in any other device in communication with the system 500.

In the example of FIG. 5, the instructions 521, when executed by the processor 510, cause the processor 510 to receive a plurality of first log data threads from one or more client applications.

The system 500 may further include instructions 522 that, when executed by the processor 510, cause the processor 510 to store in parallel the plurality of first log data threads in a plurality of logging buffers per timestamp, wherein each log buffer stores a single first timestamp log data thread.

The system 500 may further include instructions 523 that, when executed by the processor 510, cause the processor 510 to divide the first timestamp log data into a plurality of first timestamp NV segments, wherein each first timestamp NV segment is smaller in size than the first timestamp log data.

The system 500 may further include instructions 524 that, when executed by the processor 510, cause the processor 510 to flush the plurality of first timestamp NV segments into an NVM.

The system 500 may further include instructions 525 that, when executed by the processor 510, cause the processor 510 to, whereby the NVM is full, sync the flushed NV segments from the NVM to an HD in timestamp sequential order.

The above examples may be implemented by hardware, firmware, or a combination thereof. For example the various methods, processes and functional modules described herein may be implemented by a physical processor (the term processor is to be interpreted broadly to include CPU, processing module, ASIC, logic module, or programmable gate array, etc.). The processes, methods and functional modules may all be performed by a single processor or split between several processors; reference in this disclosure or the claims to a “processor” or a “processing unit” should thus be interpreted to mean “at least one processor”. The processes, methods and functional modules are implemented as machine readable instructions executable by at least one processor, hardware logic circuitry of the at least one processors, or a combination thereof.

What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

What is claimed is:

1. A system to perform Write-Ahead-Logging (WAL), the system connected to one or more client applications and to a Hard-Disk (HD) device, the client applications inputting a plurality of first log data threads to the system, the system comprising:
a processing unit coupled to one or more controllers from the one or more client applications;
a plurality of logging buffers to receive the plurality of first log data threads based on a predetermined timestamp range, wherein each log buffer stores a single first timestamp log data thread of a plurality of timestamp log data threads;
a non-volatile memory (NVM);
a flusher to flush the plurality of first timestamp log data threads from the plurality of logging buffers to a first timestamp log data, the flusher to store the first timestamp log data to the non-volatile memory (NVM) to build a flushed timestamp log data; and
a syncer to sync the flushed timestamp log data from the NVM to the HD device in timestamp sequential order.

2. The system of claim 1, wherein the predetermined timestamp range is an Epoch determined by the one or more client applications.

3. The system of claim 1, wherein the NVM is a non-volatile Dual In-line Memory Module (NVDIMM).

4. The system of claim 1, further comprising a metadata storage to store timestamp metadata.

5. The system of claim 4, wherein the metadata storage is in the NVM.

6. The system of claim 1, wherein the plurality of logging buffers are circular logging buffers.

7. The system of claim 1, further wherein
the flusher is to:
divide the first timestamp log data into a plurality of first timestamp non-volatile (NV) segments, wherein each first timestamp NV segment is smaller in size than the first timestamp log data;
flush the plurality of first timestamp NV segments into the NVM; and
the syncer to:
sync the flushed NV segments from the NVM to the HD in timestamp sequential order based on an HD storing policy previously defined by a user or client application.

8. A method to perform Write-Ahead-Logging (WAL), the method comprising:
receiving a plurality of first log data threads from one or more client applications based on a predetermined timestamp range;
storing in parallel the plurality of first log data threads in a plurality of logging buffers per timestamp, wherein each log buffer stores a single first timestamp log data thread of a plurality of timestamp log data threads;
flushing the plurality of first timestamp log data threads to a first timestamp log data from the plurality of logging buffers to a non-volatile memory (NVM) by a flusher, to build a flushed timestamp log data; and
syncing the flushed timestamp log data from the NVM to a Hard-Disk (HD) in timestamp sequential order by a syncer.

9. The method of claim 8, wherein the predetermined timestamp range is an epoch determined by the one or more of client applications.

10. The of claim 8, further comprising:
flushing the plurality of first timestamp log data threads to a first timestamp log data by dividing the first timestamp log data into a plurality of timestamp NV segments, wherein each first timestamp NV segment is smaller in size than the first timestamp log data; and
syncing the flushed NV segments from the NVM to the HD in timestamp sequential order by a syncer based on an HI) storing policy previously defined by a user or client application.

11. The method of claim 10, wherein each of the first timestamp NV segments size is decided either by a user or a client application controller.

12. The method of claim 10, wherein the timestamp NV segment can be shared by multiple timestamps divided by a marker, and the marker metadata is stored into a metadata storage.

13. The method of claim 8, further comprising storing a predetermined timestamp length parameter into a metadata storage, and opening and closing timestamps based on the predetermined timestamp length parameter.

14. The method of claim 8, wherein the flusher and the syncer are launched by a client application controller from the client application.

15. The method of claim 8, wherein the first timestamp log data from the NVM are synced in the HD asynchronously based on an HD storing policy previously defined by a user or a client application.

16. The method of claim 8, further comprising storing a timestamp barrier bookmark into a metadata storage.

17. The method of claim 16, further comprising:
recovering from a system fail within a second timestamp, wherein the first timestamp log data and a second timestamp log data are stored in the NVM; and
dropping a second timestamp log data based on the timestamp barrier bookmark previously stored in the metadata storage.

18. The method of claim 8, further comprising a client application from the one or more client applications reading the stored timestamp log data via a log cursor.

19. The method of claim 8, further comprising mapping each timestamp as a transaction and each transaction as a timestamp when a client application is not a timestamp based client application.

20. A non-transitory machine-readable medium storing machine readable instructions executable by a physical processor to cause the processor to:
receive a plurality of first log data threads from one or more client applications;
store in parallel the plurality of first log data threads in a plurality of logging buffers per timestamp, wherein each logging buffer stores a single first timestamp log data thread;
divide the first timestamp log data into a plurality of first timestamp non-volatile (NV) segments, wherein each first timestamp NV segment is smaller in size than the first timestamp log data;
flush the plurality of first timestamp NV segments into a non-volatile memory (NVM); and
whereby the NVM is full, syncing the flushed NV segments from the NVM to a Hard-Disk (HD) in timestamp sequential order.
